(19) United States
(12) Patent Application Publication
(10) Pub. No.: US 2021/0102473 A1
(43) Pub. Date: Apr. 8, 2021

(54) VARIABLE INLET GUIDE VANE ASSEMBLY HAVING EMBEDDED ACTUATOR

(71) Applicant: General Electric Company, Schenectady, NY (US)

(72) Inventor: Shivaram AC, Bangalore (IN)

(21) Appl. No.: 16/497,595

(22) PCT Filed: Apr. 6, 2018
(86) PCT No.: PCT/US2018/026475

§ 371 Date: Sep. 25, 2019

(30) Foreign Application Priority Data
Apr. 7, 2017 (IN) 201741012673

(51) Int. Cl. F01D 17/16; F02B 37/24; F01P 3/20; F01M 11/02

(52) U.S. Cl. CPC F01D 17/16; F02B 37/24; F01P 3/20; F01M 2011/021; F05D 2300/505; F05D 2300/17; F01P 2060/12; F01M 11/02

(57) ABSTRACT

A variable inlet guide vane assembly (200) and methods of operating the variable inlet guide vane assembly (200) are disclosed. The variable inlet guide vane assembly (200) includes an inlet guide vane (210) and an actuator (220). The actuator (220) is at least partially embedded in the inlet guide vane (210) and is configured to change an angle of the inlet guide vane (210) relative to a gas flow. The actuator (220) includes a shape memory alloy. The methods of operating the variable inlet guide vane assembly (200) include modulating the shape memory alloy by transferring thermal energy between the actuator (220) and a fluid, and actuating the inlet guide vane (210) to change an angle of the inlet guide vane (210) relative to gas flow.

### BACKGROUND

The present disclosure relates generally to variable inlet guide vane assemblies having an actuator in an inlet guide vane. More specifically, the present disclosure relates to a variable inlet guide vane assembly having an actuator that includes a shape memory alloy, and which is at least partially embedded in an inlet guide vane of the variable inlet guide vane assembly.

Generally, one or more turbochargers may be used along with an engine such as an internal combustion engine, to reduce size, increase fuel utilization, and to reduce emissions of the engine. A turbocharger generally includes a compressor having a compressor impeller, a turbine having a turbine wheel, and a shaft inside a bearing housing and rotatably connecting the compressor impeller and the turbine wheel and couples the turbine wheel to the compressor impeller such that rotation of the turbine wheel causes rotation of the compressor impeller. The compressor is generally connected to the engines intake manifold and the turbine is connected to the engine's exhaust manifold. The compressor supplies compressed air to the engine through the engines intake manifold. The turbine wheel is rotated by a flow of exhaust gas supplied from the exhaust manifold of the engine. To improve efficiency, responsiveness, or operating range of turbochargers, it is often advantageous to regulate the amount and direction of intake exhaust gas to the turbine. One method of regulating the amount and direction of intake exhaust gas to the turbine is by using a plurality of adjustable inlet guide vanes to direct the exhaust gas to the turbine wheel so that required amount of exhaust gas approaches the turbine wheel in a direction best suited to the engine operation.

In conventional automated systems, the inlet guide vanes of a variable inlet guide vane assembly are actuated using an actuator, which is connected to the inlet guide vanes via a lever. In conventional actuator solutions, an actuator is normally mounted outside of the turbo-machinery and the mechanical connection to the lever passes through the turbo-machinery casing. In such implementations, the vanes are being manipulated, for example, with the help of an annular ring to which each vane is coupled. The ring is acted upon by the lever or an arm connected to an electric motor, a hydraulic piston, or a pneumatic piston. This design of having an actuator external to the inlet guide vanes of the variable inlet guide vane assembly demands expensive and complicated sealing flanges for connecting the actuator to the lever. Further, such arrangements require several moving parts, such as the actuators, rings, and linkage, which are subject to mechanical stress, wear, and environmental interferences, thus making such systems particularly vulnerable to mechanical failure. Accordingly, it is desirable to have devices and methods that avoid the afore-described problems and drawbacks and ensures smooth running of the turbomachinery.

### BRIEF DESCRIPTION

In accordance with some embodiments, a variable inlet guide vane assembly is disclosed. The variable inlet guide vane assembly includes an inlet guide vane and an actuator. The actuator is at least partially embedded in the inlet guide vane and is configured to change an angle of the inlet guide vane relative to a gas flow. The actuator includes a shape memory alloy.

In accordance with some embodiments, a system including a variable inlet guide vane assembly is disclosed. The variable inlet guide vane assembly includes an inlet guide vane and an actuator. The actuator is at least partially embedded in the inlet guide vane and is configured to change an angle of the inlet guide vane relative to a gas flow. The system may be, for example, an internal combustion engine or a turbocharger.

In accordance with some embodiments, a method of operating a variable inlet guide vane assembly is disclosed. The variable inlet guide vane assembly includes an inlet guide vane and an actuator at least partially embedded in the inlet guide vane. The actuator includes a shape memory alloy. The method of operating the variable inlet guide vane assembly includes modulating the shape memory alloy by transferring thermal energy between the actuator and a fluid, and actuating the inlet guide vane to change an angle of the inlet guide vane relative to an air flow.

### DRAWINGS

These and other features and aspects of embodiments of the present disclosure will become better understood when the following detailed description is read with reference to the accompanying drawings in which like characters represent like parts throughout the drawings.

FIG. 1 is a schematic illustration of a system including an internal combustion engine and a turbocharger, in accordance with some embodiments of the present disclosure.

FIG. 2 is a schematic illustration of an inlet guide vane assembly having inlet guide vanes in an open configuration, in accordance with some embodiments of the present disclosure.

FIG. 3 is a schematic illustration of an inlet guide vane assembly having inlet guide vanes in a closed configuration, in accordance with some embodiments of the present disclosure.

FIG. 4 is a schematic illustration of an inlet guide vane including a partially embedded actuator, in accordance with some embodiments of the present disclosure.

FIG. 5 is a cross-sectional view of an inlet guide vane including a partially embedded actuator, in accordance with some embodiments of the present disclosure.

FIG. 6 is a schematic illustration of an actuator having a corrugated shape and at least partially encompassing a cavity, in accordance with some embodiments of the present disclosure.

FIG. 7 is a schematic illustration of an actuator at least partially encompassing a cavity having a corrugated shape, in accordance with some embodiments of the present disclosure.

FIG. 8 is a cross-sectional view of an actuator having a corrugated shape and at least partially encompassing a cavity having a corrugated shape, in accordance with some embodiments of the present disclosure.

FIG. 9 is a schematic illustration of a system including an internal combustion engine and a turbocharger, labelling a configuration to pass an exhaust gas to the inlet guide vane of the turbocharger, in accordance with some embodiments of the present disclosure.

FIG. 10 is a schematic illustration of a system including an internal combustion engine and a turbocharger, labelling a configuration to pass a mixture of an exhaust gas and compressed air to the inlet guide vane of the turbocharger, in accordance with some embodiments of the present disclosure.

FIG. 11 is a schematic illustration of a system including an internal combustion engine and a turbocharger, labelling a configuration to pass a mixture of an exhaust gas and ambient air to the inlet guide vane of the turbocharger, in accordance with some embodiments of the present disclosure.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

To more clearly and concisely describe and point out the subject matter, the following definitions are provided for specific terms, which are used throughout the following description and the appended claims, unless specifically denoted otherwise with respect to particular embodiments. As used herein, an “inlet guide vane” is an inlet guide vane of a variable inlet guide vane assembly that regulates the flow of intake gas to a turbine. An “actuator” is a component that is responsible for moving at least a portion of the inlet guide vane. An “actuator at least partially embedded in the inlet guide vane” refers to the actuator, at least a portion of which is inserted within at least a portion of the inlet guide vane. An “an actuator configured to change an angle of the inlet guide vane relative to a gas flow” refers to the actuator that is designed to exert a controlled amount of force to the inlet guide vane to change the angle of the inlet guide vane relative to the gas flow faced by the inlet guide vane. A shape-memory alloy is a material that changes shape in response to certain changes in temperatures. The change of shape of a shape-memory alloy in response to the temperature may manifest, for example, in a change in length, a change in volume, a change in geometry, or a combination thereof. The term “fluidly connected” refers to a physical connection that can be controlled to optionally establish a fluid transfer between the connected parts as and when required. “Modulating a shape memory alloy” refers to changing a physical characteristic of the shape memory alloy. The physical characteristic may be a shape or size.

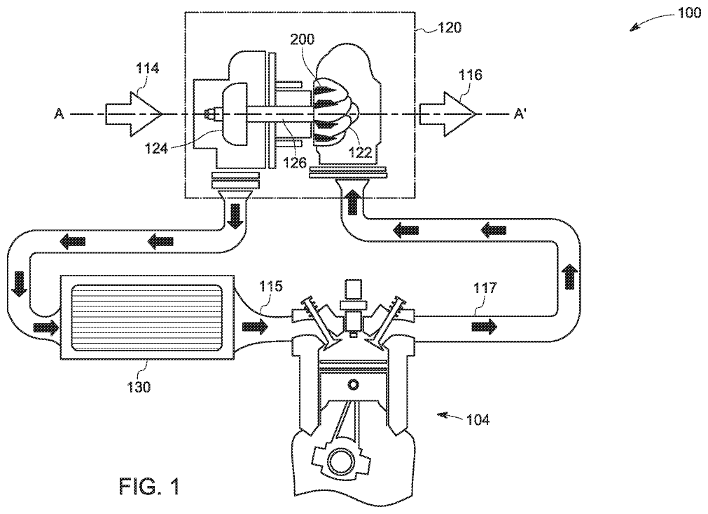

FIG. 1 schematically illustrates a system 100 in accordance with some embodiments of the disclosure. The system includes an engine 104, for example, an internal combustion engine. In some embodiments, the engine 104 may be a two-stroke engine. In some other embodiments, the engine 104 may be a four-stroke engine. The engine 104 receives intake air for combustion from an intake manifold 115. The intake manifold 115 may be any suitable conduit or conduits through which air flows to enter the engine 104. Exhaust gas resulting from combustion in the engine 104 may be supplied to an exhaust stack using any suitable conduit through which gases flow from the engine. For example, the exhaust stack may include an exhaust manifold 117.

The system 100 further includes a turbocharger 120. The turbocharger may be arranged in a position such that engine 104 receives the intake air through the turbocharger 120 and passes the exhaust gas to the turbocharger 120. In some embodiments, as shown in FIG. 1, the turbocharger 120 is arranged between an intake passage 114 and the exhaust passage 116 of the engine 104. The intake passage 114 receives ambient air. The turbocharger 120 increases air pressure of the ambient air drawn into the intake passage 114. This increased air pressure provides greater charge density during combustion thereby increasing power output and/or engine-operating efficiency of the engine 104. As depicted, the turbocharger 120 includes a turbine 122 that drives a compressor 124 via a shaft 126. The shaft mechanically couples the turbine 122 and the compressor 124. The turbine 122 and impellers (not shown in FIG. 1) of the compressor 124 are configured to rotate about an axis AA′. The system 100 may further includes parts such as a heat exchanger 130 for the intake air to increase efficiency of the system 100.

In some embodiments, a variable inlet guide vane assembly 200 may be employed in between the exhaust manifold 117 and the turbine 122 of the turbocharger 120 to direct the exhaust gas flow to the turbine 122. In such embodiments, the inlet guide vanes 210 are adjusted to control back pressure of the exhaust gas and speed of the turbocharger 120 by modulating the flow of the exhaust gas to the turbine 122. The inlet guide vanes 210 may be mounted in the turbocharger to pivot and change an angle of the inlet guide vane 210 relative to the intake exhaust gas flow from the engine 104. The setting of inlet guide vanes 210 at different positions and movements of the inlet guide vanes are determined according to the operating state of the turbocharger/engine. For example, adjusting the inlet guide vanes 210 to constrict the flow of exhaust gas increases the velocity of the exhaust gas impacting the turbine 122 which causes the turbine 122 to rotate with an increased speed. An increase in the rotation of the turbine 122 in turn increases the rotation of the impeller of the compressor 124, and thereby increases the boost pressure delivered to the engine 104. Conversely, adjusting the inlet guide vanes 210 to open the flow of exhaust gas decreases the velocity of the exhaust gas impacting the turbine 122, which causes the turbine 122 to rotate slowly. A decrease in the rotation of the turbine 122 in turn decreases the rotation of the impeller of the compressor 124, and thereby decreases the boost pressure delivered to the engine 104.

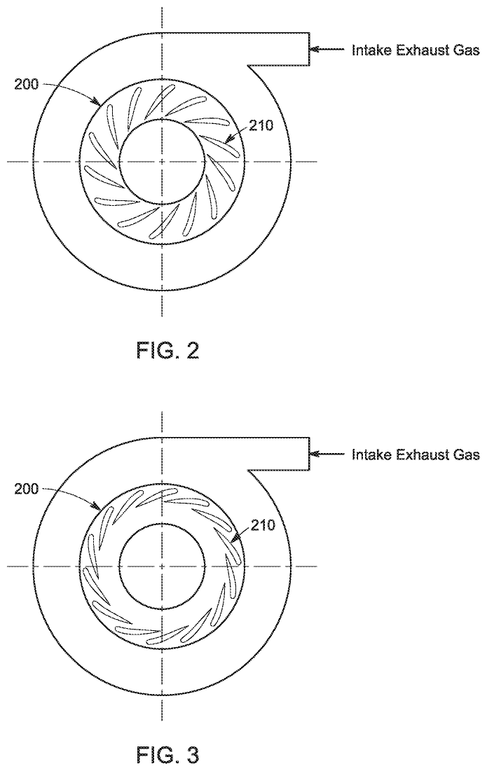

A schematic illustration of the variable inlet guide vane assembly 200 having inlet guide vanes 210 is provided in FIGS. 2 and 3. The settings and movements of the inlet guide vanes 210 may be actuated by the operation of an actuator (not shown in FIG. 2 and FIG. 3). In some embodiments, the variable inlet guide vane assembly 200 includes the actuator that is capable of actuating the vanes through a range of flow positions that extends from an open position (a position wherein the vanes have opened to allow maximum exhaust gas flow as shown in FIG. 2) to a closed position (a position wherein the vanes have closed off the exhaust gas flow to a point at which they are physically stopped as shown in FIG. 3). During operation of the turbocharger 120, rotation of turbine 122 of the turbocharger causes exhaust gas to be drawn radially inwardly through the inlet guide vanes 210.

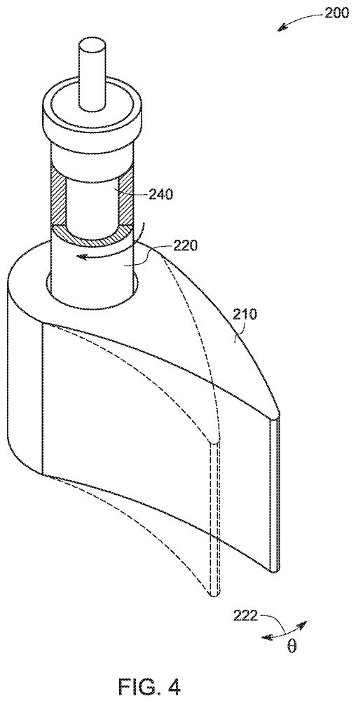

FIG. 4 schematically illustrates a part of a variable inlet guide vane assembly 200. In the embodiments of the present disclosure, the variable inlet guide vane assembly 200 includes an inlet guide vane 210 and an actuator 220. The actuator 220 is at least partially embedded in the inlet guide vane 210 and is configured to change an angle of the inlet guide vane 210 relative to an exhaust gas flow. The actuator 220 includes a shape memory alloy. In some embodiments, the variable inlet guide vane assembly 200 includes a plurality of inlet guide vanes and one or more actuators such that at least one inlet guide vane 210 of the plurality of inlet guide vanes has an actuator at least partially embedded in it. There may be more than one actuators present in each inlet guide vane. In such embodiments, the actuator/s may be positioned in different configurations with respect to the inlet guide vane and also with respect to each other actuator in the inlet guide vane. In some embodiments, the positioning of the actuators in the inlet guide vane is determined by the combined force exerted on the inlet guide vane by the actuators.

The inlet guide vane 210 may be constructed using materials such as, but not limited to, metals, alloys, plastics, ceramics, or composite materials. In some other embodiments, the inlet guide vane 210 is formed using a composite material. The composite material may provide desirable characteristics, such as, but not limited to, low weight, high strength and easy conformation to complicated shapes. The composite material may include, but not limited to, ceramic matrix composites. In some embodiments, the inlet guide vane 210 is formed of a ceramic matrix composite material that can be reliably operated at temperatures that is experienced by the turbine 122 of the turbocharger 120.

In some embodiments, the inlet guide vane 210 of the variable inlet guide vane assembly 200 may be made of a single piece. The single piece inlet guide vane may have a rigid body that can pivot about a fixed point and have an angle change with respect to a fixed point during actuation, without changing the shape of the inlet guide vane 210. In some embodiments, the inlet guide vane 210 may have a property by which the inlet guide vane 210 can twist, flex or bow in order to achieve the required variation to direct the intake exhaust gas to the turbine 122. In some other embodiments, the inlet guide vane 210 may be formed of more than one piece and include at least one fixed part and at least one movable part. In such embodiments, the at least one movable part of the inlet guide vane 210 is actuated to twist, bend or move with respect to the fixed part or some other fixed point of the variable inlet guide vane assembly 200 to control the exhaust gas intake.

The actuator 220 is at least partially embedded in the inlet guide vane 210 to actuate the inlet guide vane 210 and achieve required movements to control the gas intake. The actuator 220 may be configured to change an angle of the inlet guide vane 210 relative to an exhaust gas flow by exerting a force on the inlet guide vane 210. The angle change may occur due to angular movement of the inlet guide vane or due to at least a partial bending of the inlet guide vane 210. In some embodiments, the actuator 220, due to its shape change, exerts a twisting force to the inlet guide vane 210, thereby forcing the inlet guide vane to change an angle with respect to the gas intake. The actuator 220 may exert the force on the inlet guide vane 210, for example, in a direction 222, due to a shape change of the actuator 220, thereby forcing the inlet guide vane to turn to an angle θ. The at least partial embedding of the actuator 220 ensures adequate transfer of the force from the actuator 220 to the inlet guide vane 210.

The shape change of the actuator 220 is a result of the shape change associated with the shape memory alloy part of the actuator 220. In some embodiments, the actuator 220 includes the shape memory alloy as a major constituent, at an amount greater than 50 wt. %. In some embodiment, at least 90 wt. % of the actuator is made up of the shape memory alloy. In certain embodiments, the entire actuator 220 is formed using the shape memory alloy. A shape-memory alloy changes its shape, in a pre-determined manner, in response to certain range of temperatures. The change in shape of the shape memory alloy is due to a temperature related, solid state micro-structural phase change that enables the shape memory alloy to change from one physical shape to another physical shape. In some embodiments, the shape change of the actuator 220 may manifest as a change in the external contour of the actuator 220. In some other embodiments, a shape change may manifest as a further change in length or width, in addition to the change in the external contour.

In some other embodiments, the shape change of the actuator 220 may manifest as a change in volume. Such a change in volume of a shape memory alloy is often easily distinguishable from a change in volume due to mere thermal expansion of materials since the magnitude of change in volume of a shape memory alloy is much higher than that observed in case of a mere thermal expansion. For example, the volumetric strain of a shape-memory alloy employed herein in some of the embodiments is at least 2% of the original volume of the actuator 220, which is far beyond the volumetric strain imparted by the thermal expansion of similar alloy materials without having the shape memory characteristics. In some embodiments, a linear strain experienced by the actuator 220 due to its shape change is at least 2% of the actuator 220 at its initial shape. In some embodiments, the linear strain of the actuator 220 is at least 5% of the actuator 220 at the initial shape.

The change in shape with respect to temperature due to the shape memory effect is advantageously used for controlling shape of the actuator 220 and thereby angle θ of the inlet guide vane 210. The shape memory alloy may be trained to change shapes at certain temperatures by working and annealing a preform of the shape memory alloy at or above a temperature at which the solid state micro-structural phase change of the shape memory alloy occurs. The temperature at which such phase change occurs is generally referred to as the critical temperature or transition temperature of the shape memory alloy. In the manufacture of the actuator 220 intended to change shape during operation of the variable inlet guide vane assembly 200, the actuator 220 is formed to have one operative shape (e.g., a first shape) below a transition temperature and have another shape (e.g., a second shape) at or above the transition temperature.

The shape memory alloys used herein are characterized by a temperature-dependent phase change. These phases include a martensite phase and an austenite phase. The martensite phase generally refers to a lower temperature phase whereas the austenite phase generally refers to a higher temperature phase. The martensite phase is generally more deformable, while the austenite phase is generally less deformable. When a shape memory alloy that is in the martensite phase is heated to above a certain temperature, the phase of the shape memory alloy changes into the austenite phase. The temperature at which this phenomenon starts is referred to as the austenite start temperature (As). The temperature at which this phenomenon is complete is called the austenite finish temperature (Af). When the shape memory alloy, which is in the austenite phase is cooled, it begins to transform into the martensite phase. The temperature at which this phenomenon starts is referred to as the martensite start temperature (Ms). The temperature at which the transformation to martensite phase is completed is called the martensite finish temperature (Mf). As used herein, the term “transition temperature” without any further qualifiers may refer to any of the martensite transition temperature and austenite transition temperature. Further, the term “below transition temperature” without the qualifier of ‘start temperature’ or ‘finish temperature’ generally refers to the temperature that is lower than the martensite finish temperature, and the term “above transition temperature” without the qualifier of ‘start temperature’ or ‘finish temperature’ generally refers to the temperature that is greater than the austenite finish temperature.

In some embodiments, the actuator 220 has a first shape at a first temperature and has a second shape at a second temperature, wherein the second temperature is different from the first temperature. Further, in some embodiments, one of the first temperature or the second temperature is below the transition temperature, and the other one is at or above the transition temperature. Thus, in some embodiments, the first temperature may be below the transition temperature and the second temperature may be at or above the transition temperature, while in some other embodiments, the first temperature may be at or above the transition temperature and the second temperature may be below the transition temperature.

The shape-memory alloys used herein may have one-way or two-way shape characteristics. In some embodiments, a one-way shape memory alloy actuator 220 is in a first shape at a first temperature below the transition temperature of the shape memory alloy and transitions to a second shape (an operative shape) at a second temperature that is at or above its transition temperature. The shape memory alloy actuator remains in that operative shape even after cooling of the shape memory below the transition temperature to the first temperature. A two-way shape memory alloy actuator 220 transitions from a first shape to a second shape when the temperatures changes from a first temperature below the transition temperature to a second temperature at or above the transition temperature. The two-way shape memory alloy reverts to the first shape, or to another intermediate shape, when the temperature drops from the second temperature to the first temperature that is below the transition temperature.

In some embodiments, the actuator 220 includes a one-way shape memory alloy. In some embodiments, the actuator 220 may include some incidental materials other than the one-way shape memory alloy, wherein such incidental materials do not affect the shape memory effect-related performance of the actuator 220 by more than 5%. In certain embodiments, the actuator 220 is formed of a one-way shape memory alloy. In some embodiments, a second shape is imparted to the actuator 220 before embedding (partially or fully) the actuator 220 in the inlet guide vane 210. The second shape is the shape of the actuator 220 during the operation of the variable inlet guide vane assembly at the second temperature. In some embodiments, the second temperature is above the transition temperature of the shape memory alloy used in the construction of the actuator 220. Upon cooling to the martensite phase, the actuator 220 having the one-way shape memory alloy retains the second shape of the austenite phase. During operation, depending on the requirement of angle change of the inlet guide vane 210, the actuator 220 may be subjected to a deformation using bias loading in the martensite phase. The second shape of the actuator 220 may be recovered upon reheating the actuator 220 to above the transition temperature.

In some embodiments, the actuator 220 includes an intrinsic two-way shape memory alloy. In an intrinsic two-way shape memory alloy, the alloy shows a shape memory effect during both heating and cooling without the application of an external force to the alloy. In some embodiments, the actuator 220 may include some incidental materials other than the intrinsic two-way shape memory alloy, wherein the such incidental materials do not affect the shape memory effect-related performance of the actuator 220 by more than 5%. In certain embodiments, the actuator 220 is formed of an intrinsic two-way shape memory alloy. The intrinsic two-way shape memory behavior may be induced in the shape memory material of the actuator 220 through thermo-mechanical training. The thermo-mechanical training imparted to the actuator 220 herein may include deformation of the material while in the martensite phase, followed by repeated heating and cooling through the transformation temperature under constraint. An example of deforming may include imparting a plastic strain of at least 2%. Once the actuator 220 has been trained to exhibit the two-way shape memory effect, the shape change between the low and high-temperature states is generally reversible and persists through multiple number of thermal cycles. This trained actuator 220 may be at least partially embedded in the inlet guide vane 210 to be used during operation to control the angle of the inlet guide vane 210.

In some embodiments, the actuator 220 includes an extrinsic two-way shape memory alloy. In an extrinsic two-way shape memory alloy, the alloy shows a shape memory effect during at least one of heating or cooling after an external force is applied to the alloy. In some embodiments, the actuator 220 may include some incidental materials other than the extrinsic two-way shape memory alloy, wherein the such incidental materials do not affect the shape memory effect-related performance of the actuator 220 by more than 5%. In certain embodiments, the actuator 220 is formed of an extrinsic two-way shape memory alloy. The actuator 220 having an extrinsic two-way shape memory effect may be formed by combining a first shape memory alloy that exhibits a one-way effect with a second shape memory alloy that provides a restoring force to recover the low temperature shape. In such cases, a portion of the actuator 220 is used to induce the one-way shape memory actuation on heating, while another portion of the actuator 220 is used to provide the shape-restoring force on cooling through the transformation temperature.

Suitable shape memory alloy materials that can be used as an actuator 220 for controlling angle of an inlet guide vane include, but are not limited to, nickel-aluminum based alloys, nickel-titanium based alloys, and copper-aluminum-nickel based alloys. The alloy composition is selected to provide the desired shape memory effect for the application such as, but not limited to, transformation temperature and strain, the strain hysteresis, yield strength (of martensite and austenite phases), damping ability, resistance to oxidation and hot corrosion, ability to change shape through repeated cycles, capability to exhibit one-way or two-way shape memory effect, and several other engineering design criteria. Suitable shape memory alloys that may be employed include, but are not limited to, NiTi, NiTiHf, NiTiPt, NiTiPd, NiTiCu, NiTiNb, NiTiVd, TiNb, CuAlBe, CuZnAl and some ferrous-based alloys. In some embodiments, NiTi alloys having transition temperatures between 5° C. and 150° C. are used as a suitable shape memory alloy. NiTi alloys change from austenite to martensite upon cooling.

The actuator 220 including the shape memory alloy may be made using vacuum melting, such as vacuum induction melting, or vacuum arc melting, to form an ingot of the shape memory alloy composition. This step is optionally followed by a deformation processing of the ingot, such as rolling, extrusion, forging, drawing, and/or swaging. Alternatively, the actuator 220 may be manufactured by deposition (e.g., thermal spray, physical vapor deposition, vacuum arc deposition) or through powder consolidation. Once made, the actuator 220 may be heated to a temperature sufficient to impart the desired high temperature shape, for example, to a temperature above the austenite finish temperature.

In some embodiments, the actuator 220 may have a change in length along with the change in shape, when the shape memory alloy of the actuator 220 experiences a change in the temperatures above or below its transition temperature. Thus, in some embodiments, length of the actuator 220 at the first shape is different from the length of the actuator 220 at the second shape.

In the variable inlet guide vane assembly 200, the actuator 220 is at least partially embedded in the inlet guide vane 210. In some embodiments, the actuator 220 is integrally coupled to the inlet guide vane 210 such that the actuator 220 is an integral part of the inlet guide vane 210 at all operating conditions of the inlet guide vane 210. In some embodiments, the actuator 220 is integrally coupled with only a portion of the inlet guide vane 210, for example, as shown in FIG. 4. The portion of the inlet guide vane 210 in which the actuator 220 is embedded is a pivot through which the inlet guide vane 210 rotates for the required change in the amount and/or direction of exhaust gas intake. In some embodiments, the actuator 220 is fully embedded in the inlet guide vane 210. In some embodiments, the actuator 220 is fully embedded in the inlet guide vane 210 such that the inlet guide vane encompasses the external surface of the actuator 220. The position and coverage of the actuator 220 in the inlet guide vane 210 may vary. For example, in some embodiments, only a small portion of the actuator 220 may be inserted in the inlet guide vane covering less than 10 volume percent of the inlet guide vane 210. Further, the actuator 220 may be located in any portion of the inlet guide vane 210. The location of the actuator 220 in the inlet guide vane 210 is mostly determined by the functioning of the actuator 220 to change the angle of the inlet guide vane 210.

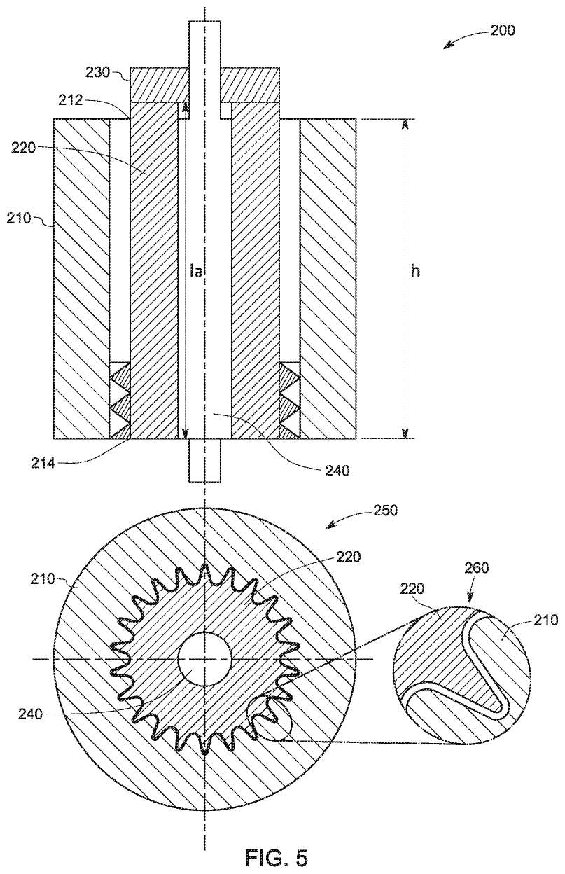

Illustration in the FIG. 5 shows the actuator 220 extending between a first tip 212 and a second tip 214 of an end portion of the inlet guide vane 210 through a height “h” of the inlet guide vane 210, depending on the required actuation in a portion or direction of the inlet guide vane, the actuator 220 may be embedded in the inlet guide vane for any depth that is less than height h of the inlet guide vane 210. Further, depending on the required actuation, the actuator 220 may be embedded in a direction that forms a finite angle with the height h of the inlet guide vane 210.

The actuator 220 having a length “la” may be flexible or rigid when existing in any of its shapes. In some embodiments, the actuator 220 is rigid, enabling effective transfer of the force from the actuator 220 to the inlet guide vane 210. In embodiments, wherein the inlet guide vane 210 includes at least a fixed portion and at least a flexible portion, the actuator 220 may be embedded in the flexible portion of the inlet guide vane 210 so that actuation does not affect the fixed portion of the inlet guide vane 210.

In some embodiments, in order to effectively actuate the inlet guide vane 210, the actuator 220 may be further affixed to a support 230 external to the inlet guide vane 210. In some embodiments, the support 230 may be a part of the variable inlet guide vane assembly 200. The actuator 220 may be affixed directly to the support 230 or, in some embodiments, for example, in embodiments where the actuator 220 is completely embedded within the inlet guide vane 210, it may be operatively coupled with the support 230 by connecting to the support 230 through an intermediate part (not shown in FIG. 5). In some embodiments, affixing of the actuator 220 to the support 230 external to the inlet guide vane 210 provides an anchor to the actuator 220 to exert force on the inlet guide vane 210.

Different methods may be used to affix the actuator 220 to the support 230. These methods include, but not limited to, physical joining, chemical joining, and mechanical joining. In some embodiments, the actuator 220 is mechanically joined to the support 230. The mechanical joining includes, without limitation, embedding, adhesive joining, capping, and attaching by using nut and bolts or rivets. In some embodiments, the actuator 220 is at least partially embedded in the inlet guide vane 210 and affixed to the support 230, without damaging and/or modifying the inlet guide vane 210 and the support 230. Further, the actuator 220 may be removed and/or replaced with another one without damaging inlet guide vane 210 and the support 230.

Although reference has been made to embedding the actuator 220 having a shape memory alloy onto the inlet guide vane 210 and/or affixing the actuator 220 to the fixed support 230, an actuator 220 having the shape memory alloy of the present disclosure may also be manufactured integrally along with the inlet guide vane 210 and/or the fixed support and the desired low temperature and high temperature shapes may be imparted to the actuator 220 as desired. For example, the actuator 220 may be manufactured along with the manufacturing of the support 230 using additive manufacturing techniques.

FIG. 5 further shows a cross-section 250 of the inlet guide vane 210 having an embedded actuator 220 with a cavity 240, according to some embodiments. In some embodiments, the cross-section 250 of the inlet guide vane 210 is at a position nearer to the second tip 214 of the inlet guide vane as compared with the first tip 212 that is proximal to the support 230. The actuator has a fin structure that mates the inlet guide vane 210 at certain points making a spline joint with the inlet guide vane, as can be seen from a further exploded view 260 of a part of the cross-section 250. During operation of the variable inlet guide vane assembly 200, a shape change in the actuator 220 makes the fin structure of the actuator 220 displace from the original position, thus forcing the correspondingly mated inlet guide vane 210 portion to turn along with the actuator displacement. This imparts an overall twisting movement to the inlet guide vane 210 with the support 230 as a pivot.

In some embodiments, the actuator 220 may further have a change in length, when the actuator 220 experiences a change in the temperatures above or below its transition temperature. Thus, in some embodiments, length la of the actuator 220 at the first shape is different from the length la of the actuator 220 at the second shape. A shape change of the actuator 220 is effected by the corresponding change in shape of the shape memory alloy part of the actuator 220. In some embodiments, wherein the actuator 220 has the shape memory alloy as a major constituent, the change in shape of the shape memory alloy part of the actuator 220 may directly manifest as the change in shape of the actuator 220. The shape (first shape and/or the second shape) and length la (length at the first shape and/or length at the second shape) of the actuator 220 may be pre-determined to achieve the desired actuation of the inlet guide vane 210 at all operating conditions of the variable inlet guide vane assembly 200. A change in temperature between the first shape and the second shape of the actuator 220 is effected by a change in the temperature of the actuator 220. Different methods may be used to change temperature of the actuator 220 at the required time duration and required amount. Non-limiting methods of changing temperature of the actuator 220 include electrical heating, induction heating, and heating by a heat transfer between the actuator 220 and a fluid.

In some embodiments, the change in temperature of the actuator 220 for the change in shape is achieved by a heat transfer between the actuator 220 and a fluid. To facilitate this, in some embodiments, the inlet guide vane 210 includes a cavity 240 that is proximal to the actuator 220, as illustrated, for example, in FIGS. 4 and 5. The cavity 240 may be used for passage of the fluid that can transfer heat energy to the actuator 220. The size, shape and orientation of the cavity 240 may be designed to ensure efficient transfer of required amount of thermal energy to the actuator 220. The cavity 240 is different from any other cavity structure that may be present as a part of the inlet guide vane 210. While the other cavity structures may be present in the inlet guide vane 210 for aerodynamic and overall cooling purposes, the cavity 240 is particularly proximal to the actuator such that there is a controlled thermal energy transfer between a fluid passing through the cavity and the actuator as and when required. In certain embodiments, the actuator 220 encompasses the cavity 240 such that the passage of the fluid through the cavity 240 effectively and controllably changes the temperature of the actuator 220 for providing the required angle change of the inlet guide vane 210.

In some embodiments, the cavity 240 is in direct contact with the actuator 220. In some other embodiments, where the cavity 240 is not in direct contact with the actuator 220 (i.e., when the fluid passing through the cavity does not touch the actuator 220), materials of known high thermal conductivity may be used in between the actuator 220 and the cavity for the optimal heat transfer between the actuator 220 and the cavity. There may be more than one cavity 240 present in an inlet guide vane 210.

In some embodiments, the actuator 220 and the cavity 240 are designed and positioned such that the actuator 220 at least partially encompasses the cavity 240. The actuator 220 is said to encompass the cavity, if the actuator 220 surrounds the cavity at least in two directions. In some embodiments, the cavity 240 is in a tube form configured to pass a fluid. The cavity 240 may be a through hole to allow the passing of the fluid and the through hole may be surrounded by the actuator 220 to enhance heat transfer to the actuator 220. In some embodiments, the actuator 220 may be surrounded by the cavity 240. In certain embodiments, the actuator 220 may be surrounding one cavity 240 and another cavity may at least partially surround the actuator 220 to impart a further enhanced and faster heat transfer between the actuator 220 and the fluid passing through the cavities 240. In the embodiments, wherein the cavity 240 at least partially surrounds the actuator 220, the actuator 220 may be physically affixed to the inlet guide vane 210 in at least some positions such that the force exerted by the shape change of the actuator 220 is effectively transferred to the inlet guide vane 210. In some embodiments, at least a part of the cavity is located in a longitudinal direction of the actuator 220 so that a large portion of the actuator 220 can be influenced by temperature of the fluid passing through the cavity 240.

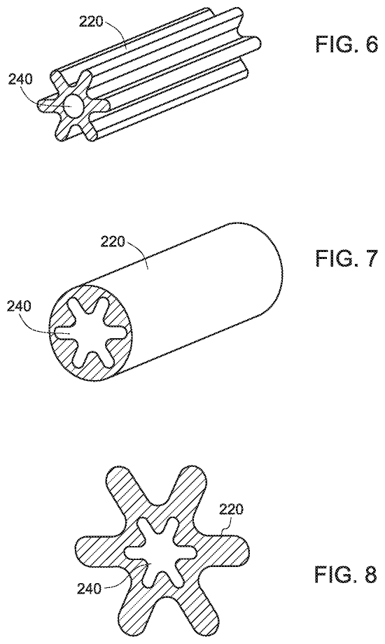

The shape of the actuator 220 and/or the cavity 240 may be designed to enhance and/or expedite heat transfer between the actuator 220 and the fluid. In some embodiments, the actuator 220 has a corrugated shape. In some embodiments, the cavity 240 has a corrugated shape. Some representative but non-limiting examples of the shape of the actuator 220 and shape of the cavity 240 are illustrated in FIGS. 6-7. FIG. 6 illustrates an actuator 220 having a corrugated shape and encompassing the cavity 240, and FIG. 7 illustrates the actuator 220 encompassing a cavity 240 having corrugated shape. FIG. 8 illustrates a cross-section perpendicular to length la (shown in FIG. 5) of a corrugated actuator 220 encompassing a corrugated cavity 240. The shapes of the actuator 220 and the cavity 240 may have any corrugation, and may or may not be similar to each other.

The actuator 220 actuates the inlet guide vane 210 to change angle by exerting a force due to the shape change of the actuator 220. In some embodiments, the changed angle of the inlet guide vane 210 may need to be retained for a longer time duration. For this time duration, in some embodiments, the heat transfer to the actuator 220 is supplied continuously. In some other embodiments, the inlet guide vane 210 may be locked in the changed angle position for the required time duration even if the actuator 220 experiences a further change in temperature. Thus, in some embodiments, the variable inlet guide vane assembly 200 includes a locking mechanism configured to retain the change in the angle of the inlet guide vane, such as, for example, a Pawl-Ratchet mechanism. The locking mechanism may be adapted for locking the angle of inlet guide vane 210 in open position, closed position, or any other position in between the open and closed positions. The locking mechanism may be removed when the inlet guide vane 210 is required to be moved from the locked position by many means, for example, using a solenoid or a return spring.

In some embodiments, the variable inlet guide vane assembly 200 includes a plurality of circumferentially spaced inlet guide vanes. For the effective control on the intake exhaust gas, more than one inlet guide vanes 210 of the plurality of inlet guide vanes may need to change the angle with respect to the inlet gas flow. In some embodiments, the actuation of one inlet guide vane 210 by the act of actuator 220 may further be transitioned to one or more inlet guide vanes of the plurality and required number of inlet guide vanes may be stimulated to change the angles accordingly. In some embodiments, all the inlet guide vanes of the variable inlet guide vane assembly are stimulated to change the angle to the predetermined angle by the action of an actuator 220 at least partially embedded in at least one of the inlet guide vane 210. In some embodiments, more than one inlet guide vanes of the variable inlet guide vane assembly include respective embedded actuators. In some embodiments, the more than one inlet guide vanes include at least partially embedded actuators. In certain embodiments, all the individual inlet guide vanes of the variable inlet guide vane assembly have at least partially embedded actuators. In some embodiments, the actuator 220 of one inlet guide vane 210 is connected to an actuator 220 of another inlet guide vane 210. In some other embodiments, the actuators of the individual inlet guide vanes are distinct and are separated by each other.

In certain embodiments, a variable inlet guide vane assembly is disclosed. The variable inlet guide vane assembly includes a plurality of inlet guide vanes and a plurality of actuators. Each inlet guide vane 210 of the plurality of inlet guide vanes is embedded with at least one actuator 220 selected from the plurality of actuators. The at least one actuator 220 is embedded in the inlet guide vane 210 such that a shape change of the actuator 220 makes the inlet guide vane 210 move or flex in an angle, the angle being determined by the extent of shape change of the actuator 220. The actuator 220 is further affixed to a support 230 and encompasses a through hole 240 having a corrugated shape.

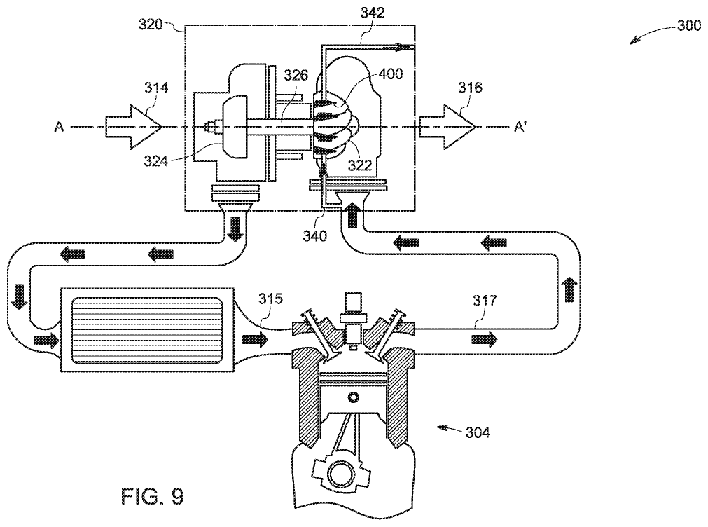

In one aspect, a system 300 is disclosed as shown in FIG. 9. The system 300 includes an internal combustion engine 304. The turbocharger 320 includes a variable inlet guide vane assembly 400. The engine 304 receives air for combustion from an intake passage 314 through an intake manifold 315. Exhaust gas resulting from combustion in the engine 304 is supplied to an exhaust passage 316 through an exhaust manifold 317.

The internal combustion engine 304 is connected to a turbocharger 320 arranged between the intake passage 314 and the exhaust passage 316 of the engine 104. The turbocharger 320 includes a turbine 322 which drives a compressor 324 via a shaft 326. The turbine 322 and impellers (not shown in FIG. 9) of the compressor 324 rotate about an axis AA′. The turbocharger 320 of the system 300 further includes a variable inlet guide vane assembly 400. The variable inlet guide vane assembly 400 includes an inlet guide vane and an actuator. The actuator is at least partially embedded in the inlet guide vane and is configured to change an angle of the inlet guide vane relative to an exhaust gas flow. The actuator includes a shape memory alloy. The actuator that includes the shape-memory alloy may be designed to change shape in response to the temperatures experienced by the actuator while in use. For example, the actuator may be manufactured and thermo-mechanically trained to facilitate the change in shape of the actuator during operation of the variable inlet guide vane assembly.

In some embodiments, the actuator of the variable inlet guide vane assembly 400 is fully embedded in the inlet guide vane. In some embodiments, the variable inlet guide vane of the inlet guide vane assembly 400 includes a cavity that is proximal to actuator. In some embodiments, the actuator encompasses the cavity. The cavity is configured to pass a fluid through it. The cavity may have any shape that permits heat transfer between the actuator and the fluid passing through the cavity. In some embodiments, the shape memory alloy of the internal combustion engine includes a NiTi alloy. In an exemplary embodiment, the actuator is constructed of NiTi shape memory alloy and is operated in the temperature range from about 5° C. to about 150° C. In some embodiments, the NiTi shape memory alloy has about 50 atomic % of nickel. In some embodiments, more than one inlet guide vanes have at least partially embedded actuator. In some embodiments, the variable inlet guide vane assembly includes a plurality of circumferentially spaced inlet guide vanes.

In one aspect, a method of operating a variable inlet guide vane assembly such as the variable inlet guide vane assembly 400 in the system 300 is disclosed. The variable inlet guide vane assembly 400 includes an inlet guide vane and an actuator. The actuator is at least partially embedded in the inlet guide vane and the actuator includes a shape memory alloy. The method of operating the variable inlet guide vane assembly includes modulating the shape memory alloy by transferring thermal energy between the actuator and a fluid and thereby actuating the inlet guide vane to change an angle of the inlet guide vane relative to an exhaust gas flow.

In some embodiments, the step of transferring the thermal energy between the actuator and the fluid includes passing the fluid through a cavity present in the inlet guide vane and located proximal to the actuator. In embodiments, wherein the actuator at least partially encompasses the cavity, the shape of the actuator and the cavity may be designed to have maximum heat transfer between the fluid and the actuator during the actuation of the inlet guide vane. Any fluid that may be carrying the thermal energy to be transferred to the actuator or is capable of absorbing heat from the actuator may be used for the thermal energy transfer. In some embodiments, a fluid that is already disposed in the system, for example, the internal combustion engine 304 is employed for the actuation. Non-limiting examples of the fluids that can be used for heat transfer include exhaust gas, coolant fluid, or lubricating oil of the internal combustion engine. Thus, in some embodiments, the step of passing the fluid through the cavity includes passing at least one of exhaust gas, coolant fluid, or lubricating oil through the cavity. The fluids may be directed to or circulated in the cavity. During passage of the fluid, the thermal energy of the fluid gets transferred to the actuator and actuates the inlet guide vane. The original or intermediate angles of the inlet guide vanes may be achieved by passing a cool fluid or by at least partially disengaging the fluid flow through the cavity. For example, the exhaust gas of the internal combustion engine is always hot and may be capable of heating up the actuator to a second temperature that is above the transition temperature of the shape memory alloy of the actuator. Therefore, the exhaust gas may be passed through the cavity, when the actuator needs to be heated up to change the angle of the inlet guide vane, and the passage of exhaust gas through the cavity may be disconnected when the inlet guide vane is supposed to return and remain in the original position that correspond to the first shape of the actuator that is below the transition temperature. Similarly, hot and relatively cool fluids may be mixed appropriately in a flow regulator to achieve required temperatures for transformation.

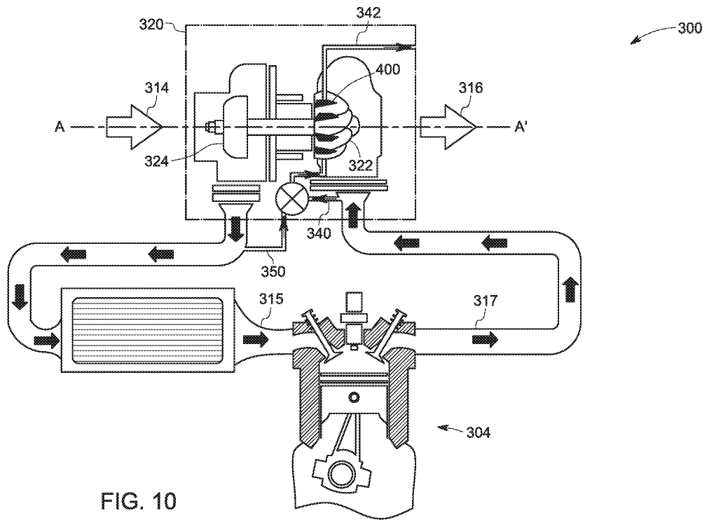

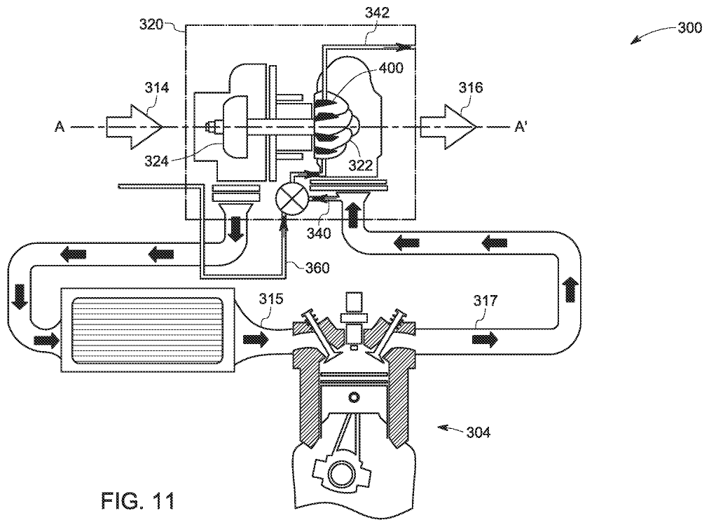

FIG. 9 further illustrates a subsidiary 340 of the exhaust manifold 317 connected to the turbocharger 320. The exhaust gas flowed through the subsidiary 340 is passed through a cavity of the inlet guide vane assembly to change temperature of the actuator that is at least partially embedded in the inlet guide vane of the variable inlet guide vane assembly 400. Thus, hot exhaust gas from the internal combustion engine 304 may be passed through the subsidiary exhaust manifold 340 to the actuator to change temperature of the actuator. The exhaust gas passed through the actuator may be emitted through a subsidiary exhaust passage 342. In some embodiments, the exhaust gas from the exhaust manifold 317 of the engine 304 may be mixed with the compressed air as shown in FIG. 10 for controlling temperature of the fluid used for shape change of the actuator. The compressed air may be passed through a subsidiary of the compressed air 350 and mixed in the required proportion with the exhaust gas before passing through the cavity to change the shape of the actuator. In some embodiments, the intake air to the system 300 may be used as an alternative to or in addition to the compressed air, as illustrated in FIG. 11.

In some embodiments, a coolant liquid may be used as the fluid for heat transfer. The heated coolant may be used to heat the actuator to the second shape and thereby change the angle of the inlet guide vane. The coolant may pass through a heat exchanger to lose its heat and the cooled coolant may be used to bring back the actuator to the first shape to change the angle of the inlet guide vane to that corresponding to the first shape of the actuator.

A control algorithm may be used to for the decision about passing the fluid through the cavity. Thus, in some embodiments, the step of passing the fluid through the cavity is in response to a control algorithm of the variable inlet guide vane assembly. In some embodiments, the step of modulating the shape memory alloy includes modulating at least one of shape or size of the shape memory alloy. The amount of the force that is applied to the inlet guide vane may be determined by a sensor associated with the system 300.

In one aspect, the present disclosure allows to reduce the amount of mechanical parts needed for inlet guide vane actuation to a minimum, while providing for immediate controllability, and thus significantly enhances the reliability of operation and simplifies its practical application in compressors. Reduced relative motion of the variable inlet guide vane assembly reduces wear and tear of the assembly and increases reliability. A self-sufficient actuation by using an engine fluid avoids the need for any external power supply such as electric power, hydraulic power, or pneumatic power. The variable inlet guide vane assembly disclosed herein is generally suited to a turbocharger of an internal combustion engine. Non-limiting examples where the inlet guide vane assembly disclosed herein may be used include the compressor of a turbocharger or an inlet fan assembly of a combustion engine.

### Example

The following example is merely illustrative, and should not be construed to be any sort of limitation on the scope of the claimed disclosure. The wires and foils used hereinbelow were procured from Dynalloy Inc. (USA), and tubes were procured from Johonson matthey Inc. (USA).

In one experiment, a tube formed from a NiTi alloy was held in place by fixing one end of the tube to an airfoil and the other end to a fixed support and heated by blowing hot air on the external surface of the tube. It is observed that the NiTi alloy tube applied a significant amount of torque to recover its original geometry. This experiment was repeated multiple times for twist, bend, and twist-bend combinations of the NiTi alloy tubes to demonstrate robustness of actuation obtained by the shape memory alloy tubes.

In another set of experiments, a 1.6 mm NiTi wire was trained to remember a bent shape in hot condition. Later, this pre-trained wire was deformed in cold condition of about 25° C., and heated using hot air blower to about 60° C. The NiTi alloy wire demonstrated shape recovery. The above-mentioned tests were repeated multiple times on different wires and foils to demonstrate the shape recovery.

The foregoing embodiments are selected embodiments from a manifold of all possible embodiments of the claimed disclosure. The foregoing embodiments are therefore to be considered in all respects as illustrative rather than limiting. The claimed disclosure may be embodied in other specific forms without departing from the spirit or essential characteristics thereof. While only certain features of the claimed disclosure have been illustrated, and described herein, it is to be understood that one skilled in the art, given the benefit of this disclosure, will be able to identify, select, optimize or modify suitable conditions/parameters for using the methods in accordance with the principles of the present disclosure, suitable for these and other types of applications. This written description uses some examples to disclose the claimed disclosure, including the best mode, to enable any person skilled in the art to practice the disclosure, including making and using any devices or systems and performing any incorporated methods. The scope of the claimed disclosure may include other examples that occur to those skilled in the art. Such other examples are intended to be within the scope of the appended claims if they have structural elements that do not differ from the literal language of the claims, or if they include equivalent structural elements with insubstantial differences from the literal language of the claims.

1-20. (canceled)

21. A variable inlet guide vane assembly comprising:
an inlet guide vane; and
an actuator, at least partially embedded in the inlet guide vane and configured to change an angle of the inlet guide vane relative to a gas flow,
wherein the actuator comprises a shape memory alloy.

22. The variable inlet guide vane assembly of claim 21, wherein the actuator comprises the shape memory alloy as a major constituent.

23. The variable inlet guide vane assembly of claim 21, wherein the shape memory alloy comprises a NiTi alloy.

24. The variable inlet guide vane assembly of claim 21, wherein the actuator is fully embedded in the inlet guide vane.

25. The variable inlet guide vane assembly of claim 21, wherein the inlet guide vane comprises a cavity that is proximal to the actuator.

26. The variable inlet guide vane assembly of claim 25, wherein the actuator at least partially encompasses the cavity.

27. The variable inlet guide vane assembly of claim 25, wherein the cavity has a corrugated shape.

28. The variable inlet guide vane assembly of claim 21, wherein the actuator is further affixed to a support external to the inlet guide vane.

29. The variable inlet guide vane assembly of claim 21, further comprising a locking mechanism configured to retain the change in the angle of the inlet guide vane.

30. The variable inlet guide vane assembly of claim 21 comprising a plurality of circumferentially spaced inlet guide vanes.

31. A system comprising: a variable inlet guide vane assembly comprising:
an inlet guide vane; and
an actuator, at least partially embedded in the inlet guide vane and configured to change an angle of the inlet guide vane relative to a gas flow,
wherein the actuator comprises a shape memory alloy.

32. The system of claim 31, wherein the variable inlet guide vane assembly comprises a plurality of circumferentially spaced inlet guide vanes.

33. The system of claim 31, wherein the actuator is fully embedded in the inlet guide vane.

34. The system of claim 31, wherein the inlet guide vane comprises a cavity that is proximal to the actuator.

35. The system of claim 31, wherein the shape memory alloy comprises a NiTi alloy.

36. A method of operating a variable inlet guide vane assembly comprising an inlet guide vane and an actuator at least partially embedded in the inlet guide vane, wherein the actuator comprises a shape memory alloy, the method comprising:
modulating the shape memory alloy by transferring thermal energy between the actuator and a fluid; and
actuating the inlet guide vane to change an angle of the inlet guide vane relative to a gas flow.

37. The method of claim 36, wherein transferring thermal energy between the actuator and the fluid comprises passing the fluid through a cavity present in the inlet guide vane and at least partially encompassed by the actuator.

38. The method of claim 37, wherein passing the fluid through the cavity comprises passing at least one of exhaust gas, coolant fluid, or lubricating oil through the cavity.

39. The method of claim 37, wherein passing the fluid through the cavity is in response to a control algorithm of the variable inlet guide vane assembly.

40. The method of claim 36, wherein modulating the shape memory alloy comprises modulating at least one of shape, or size of the shape memory alloy.
